(19) United States
(12) Patent Application Publication
(10) Pub. No.: US 2003/0148244 A1
(43) Pub. Date: Aug. 7, 2003

(54) Articulator, specifically for applications in dentistry and dental technique

(76) Inventor: Lorenzo Battistutta, Solaro (IT)

Correspondence Address: Chernoff Vilhauer, McClung & Stenzel, Attorneys at Law 1600 Ods Tower, 601 SW Second Avenue, Portland, OR, 97204-3157, US

(21) Appl. No.: 10/311,125

(22) PCT Filed: Jun. 11, 2001
(86) PCT No.: PCT/EP01/06573

(30) Foreign Application Priority Data
Jun. 15, 2000 (IT) MI2000A001336

(51) Int. Cl. A61C 11/00

(52) U.S. Cl. 433/65; 433/56

(57) ABSTRACT

An articulator, specifically for applications in dentistry and dental technique, including a lower base (2) and an upper base (3) reciprocally attached at the joints (6, 7) placed at a variable height or distance from the base (3) of the articulator, in order to allow the occlusal plane of the dental arches to be positioned at the correct level on the condylar axis.

This invention regards an articulator, specifically for applications in dentistry and dental technique.

The field of application of this invention is that of articulators, which, in dentistry and dental technique, are used to simulate the movement of the dental arches and for the fabrication of prosthetic devices. In this field are known articulators used in the laboratory to facilitate the reproduction of the exact position of the dental arches as recorded in the patient's mouth, with the use of suitable facebows. These commonly known articulators consist of a lower supporting base and an upper mounted base that oscillates, in relation to the lower, from the joining points located at the height of the upper base itself. The models of the dental arches are placed between these bases, in order to simulate their occlusion.

Conventional examples of this kind have the disadvantage that, in the case of models positioned horizontally, there are problems of more space being occupied; in order to solve such problems, the exact reproduction in laboratory of the level of the occlusal plane in relation to the condylar axes is compromised.

Another problem regarding conventional articulators is the fact that their articulated connection of the two bases requires the use of auxiliary fasteners.

The main purpose of this invention is to provide a new articulator that makes it possible for dental technicians to improve the correct reproduction of the position of the dental arches.

Another purpose of this invention is to provide an articulator of the above-mentioned type, but more versatile than conventional models.

The invention also has the purpose of providing an articulator capable of ensuring a perfect parallelism between the bases of the articulator itself, held on the horizontal plane, as well as between the latter and the occlusal plane.

Finally, the invention aims to provide an articulator that is simpler and easier to use than conventional models.

These and other purposes are fulfilled by the articulator in claim 1. Further characteristics of the articulator in question can be found in the remaining claims.

In comparison with traditional articulators, the one in this invention, thanks to the movement of the joints below the upper base, allows the occlusal plane of the dental arches to be positioned at the correct level on the condylar axis. In this way it is possible to vary the reference height of the condylar axis, so as to adapt it to that of the occlusal plane recorded by the dentist.

Furthermore, according to the invention, the possibility of also using the upper base in an inverted position offers the advantage of simulating both the centric relation movement (that which determines the centric contact point between the teeth of the respective dental arches) and lateral movements (those regarding the movement of the dental arches on the occlusal plane), whilst using the same base.

Moreover, the invention offers the advantage of guaranteeing a perfect parallel between the articulator's bases, as well as between the latter and the occlusal plane.

The articulator in question has the further advantage of permitting the quick replacement of the condylar boxes with others having a more or less accentuated curvature of the condylar eminence, possibly shaped individually.

Finally, the use of a magnetic connection between the bases offers the advantage of allowing rapid reciprocal articulation, moreover by the use of simpler means than those used in conventional devices.

These and other characteristics and advantages are to be seen in the following description of a preferred way of fabricating the articulator in question that is shown, as a non-restrictive example, in the figures on the attached illustration tables. In these, which are an integral part of this description:

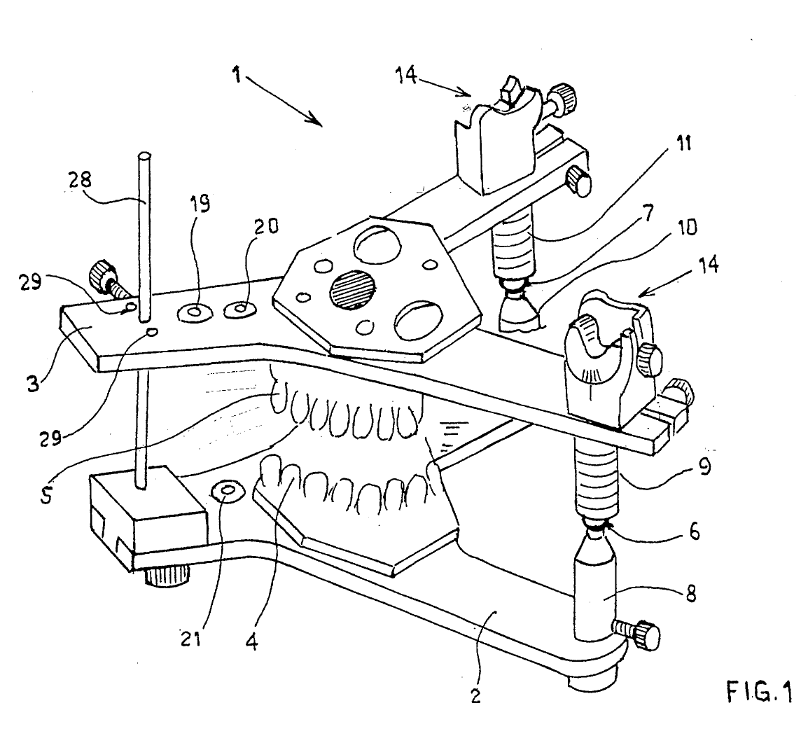

FIG. 1 illustrates the articulator in question in an overall perspective view;

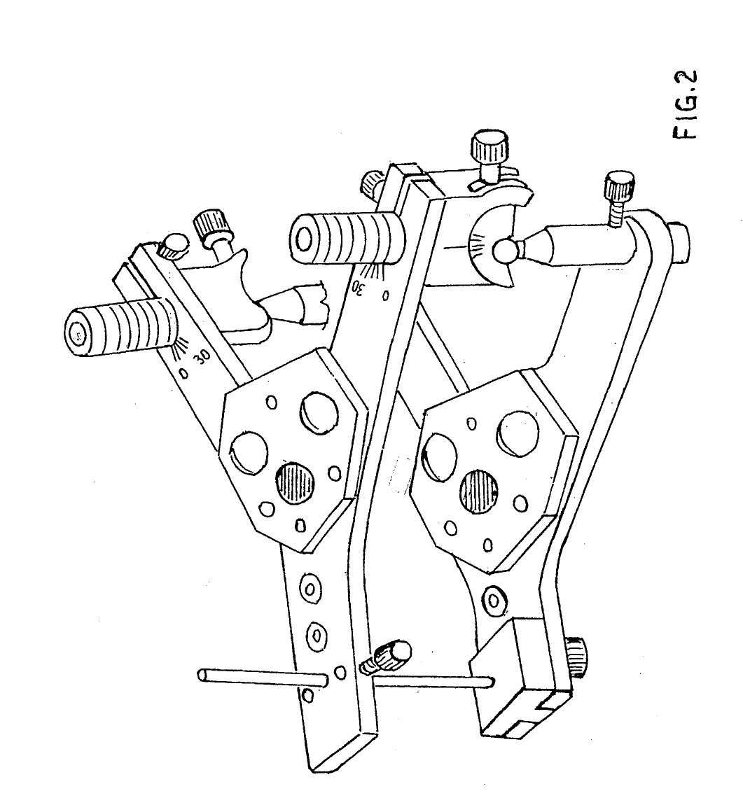

FIG. 2 illustrates the articulator in FIG. 1 with the upper base in an inverted position;

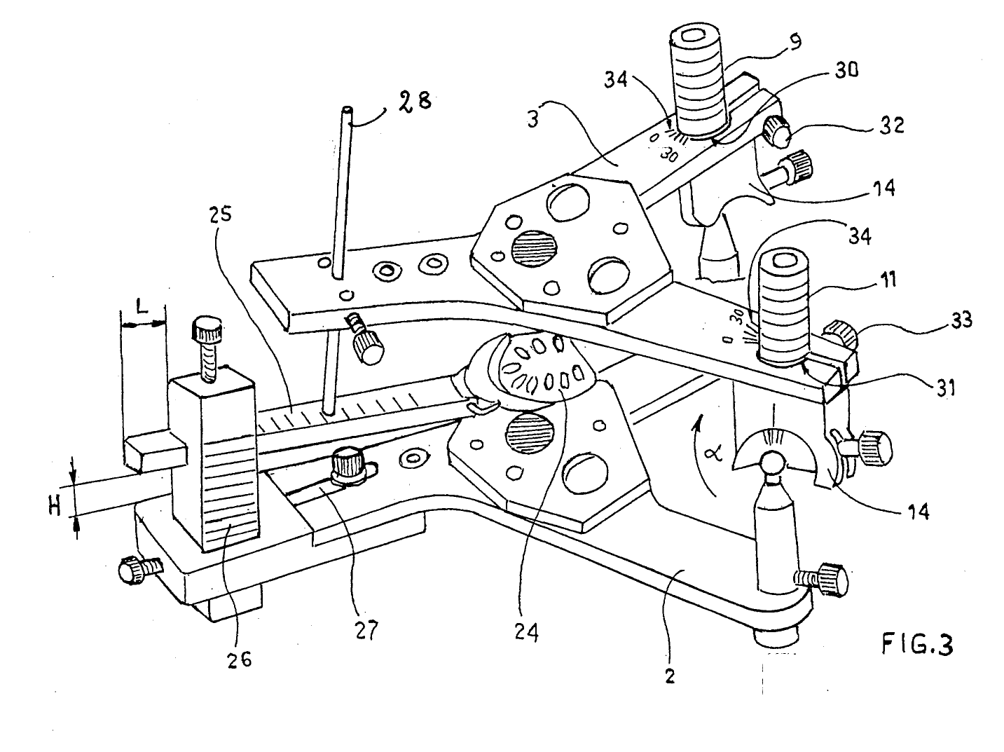

FIG. 3 illustrates the articulator in FIG. 2, completed with the bite fork that bears the impression of the cusp of the teeth;

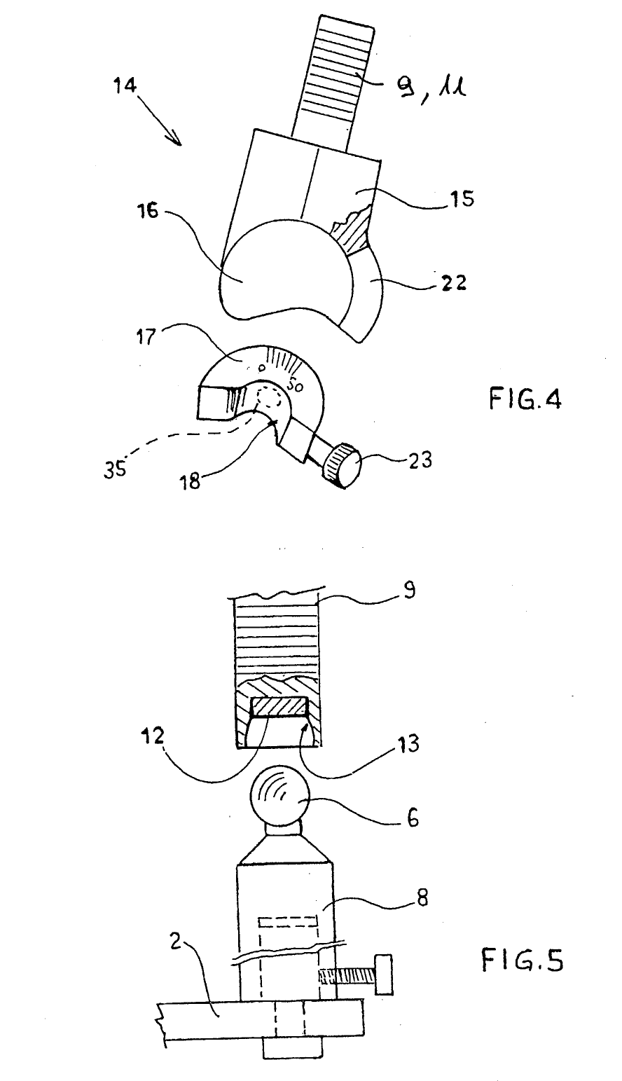

FIG. 4 shows the exploded view of the detail of the condylar boxes provided on the articulator in question;

FIG. 5 shows the detail of the joint between the two bases of the articulator in FIG. 1;

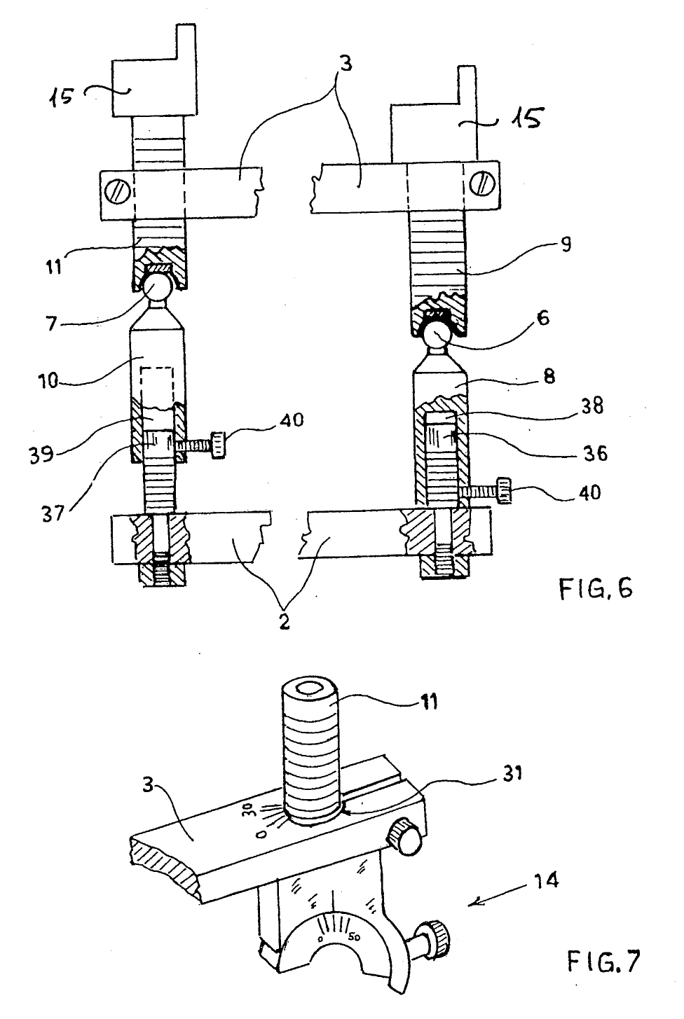

FIG. 6 illustrates the articulator in FIG. 1, in the version that allows the regulation of the height of the column portions; and

FIG. 7 shows the detail of the condylar boxes in FIG. 4, as mounted on the articulator.

The articulator in question is indicated as a whole with a 1 in FIG. 1. It consists of a lower base 2 and an upper base 3, between which the models of dental arches respectively lower 4 and upper 5.- are placed.

The above-mentioned base 3 is mounted to oscillate in relation with the lower base 2 starting from joints 6 and 7, which are spherical or in the shape of a natural condyle. These joints are notable for the fact that they are adjustable in height, measured on the respective column portions 8, 9 and 10, 11 of bases 2 and 3, which reproduce the position of the condylar axes of the patient's mouth. This height indicates the relation between the occlusal plane of the teeth and the condylar axis.

Thanks to the possibility of regulating the height or the distance of the occlusal plane below the upper base 3, the articulator can contain models 4 and 5 of the dimensions desired, whilst conserving the correct position of the occlusal plane (which passes through the point of contact of the dental arches) relative to the condylar axes (which coincide with the position of columns 8, 9 and 10, 11) and relative to the horizontal plane.

In particular, as can be better seen in FIG. 5, on the column portions 8 and 10 of the base 2, which bear the spherical joints 6 and 7, fit the corresponding column portions 9 and 11 of the upper base 3, equipped at the end with hollow seats suitable for receiving the above-mentioned spherical joints. This fitting, advantageously secured with suitable magnets 12 placed inside the column portions 9 and 11 and corresponding with the above-mentioned hollow seats, makes it possible to measure the degree of centric relation movement of the dental arches.

In order to allow lateral movements as well, on the opposite side of the base 3, which bears the above-mentioned column portions 9 and 11, the condylar boxes 14 are foreseen, as better illustrated in FIG. 4. These condylar boxes basically consist of a block 15, which bears a containing seat 16, with the possibility of rotating, of a revolving cursor 17, in the shape 18 of the curvature representing the condylar eminence of the patient's mouth.

It has the advantage that the said block 15 has a slit 22, which develops along part of seat 16, suitable for a setting screw 23 to hold the cursor 17 inside the block 15 itself. Alternatively, the screw 23 may be placed directly inside the block 15. In this way it is possible to replace, on the block 15, the cursors 17 which have the correct profile of the condylar eminence (chosen by the dentist). Also in FIG. 4 you can see at 35 a magnet suitable to integrate the cursor 17 with its relative joint 6, 7 in the inverted position (FIGS. 2 and 3) of the upper base 3.

According to this invention, the upper base 3 can actually be used, in the position illustrated in FIGS. 2 and 3, inverted relative to the previous figure, in order to allow you, with the use of the same articulator, to find both the centric position (FIG. 1) and that of the lateral movements (FIGS. 2 and 3). The horizontality of the articulator is guaranteed by the water levels 19 and 20, on both sides of the upper base 3, and by the water level 21 on the upper face of the base 2 (FIG. 1).

In use, the bite fork 24 that bears the impression of the cusp of the teeth is supported by a millimetric horizontal rod 25, which in turn is mounted on a millimetric vertical rod 26, fixed and sliding on rail 27, which is integral with the base 2. The dentist thus reads on rod 26 the height H, on rod 25 the length L and on the incisal rod 28 the angle α that were previously measured in the patient's mouth. The reproduction of these values on the articulator allows the technician to obtain the correct position of the models in the laboratory.

In particular we can note that, according to this invention, it is possible to modify the height or the position of the joints 6, 7 on the column portions 8, 9 and 10, 11, even independently, in order to make the horizontality of the upper base compatible with the variations of position of the patient's condylar joints. For this purpose, as is better illustrated in FIG. 6, the column portions 9 and 11 are graduated and are mounted to slide and rotate within the corresponding seats 30, 31 of the said base 3 and can be blocked on it using screws 32, 33.

The corresponding column portions 8 and 10 of the lower base 2 can also be regulated for height, in order to compensate for the difference created by the modification of column portions 9 and 11, thus conserving, as mentioned, the horizontality or the parallelism in general of the upper base 3 relative to the lower one 2. For this reason, the said column portions 8 and 10 include seats 38 and 39, within which are located millimetric sliding pins 36 and 37, which in turn are integral with the lower plate 2. Screws 40 can be used to set these pins within their seats 38 and 39, once the plate 3 has achieved a horizontal position.

Furthermore, in order to prevent the incisal rod from disturbing the view of the patient's mouth, the upper base 3 can include several seats 29 for housing the rod 28 in different positions, as chosen by the operator. The angular position of the condylar boxes 14 can be determined using a goniometric scale 34, created on the lower face of the base 3.

1. An articulator, particularly for applications in dentistry and dental technique, including a lower base (2) and an upper base (3), reciprocally joined, with the possibility of moving the base (3) in relation to the other (2), suitable for holding the respective models (5, 4) of the patient's dental arches, characterised by the fact that it includes suitable means to vary the height or the distance of the occlusal plane relative to the said upper base (3) of the articulator.

2. Articulator, according to claim 1, characterised by the fact that the said means consist of joints (6, 7) present on the column portions (8, 9; 10, 11) connecting the said bases (2,3).

3. Articulator according to claim 2, characterised by the fact that the said joints are spherical or have the form of natural condyles.

4. Articulator according to one or more of the claims above, characterised by the fact that the said joints (6, 7) are present on the column portions of one of the said bases, with hollow seats (13) suitable for the above-mentioned joints, being positioned at the ends of the column portions of the remaining base.

5. Articulator according to claim 4, characterised by the fact that it also includes magnets (12) situated in correspondence with the said hollow seats (13).

6. Articulator according to one or more of the claims above, characterised by the fact that the said upper base (3) includes, on the side opposite the said column portions (9, 11), condylar boxes (14).

7. Articulator according to claim 6, characterised by the fact that the said condylar boxes (14) consist of a block (15) provided with a containing seat (16) offering the possibility of rotation, of a revolving cursor (17) which has the shape (18) of the curvature representing the patient's condylar eminence.

8. Articulator according to one or more of the claims above, characterised by the fact that the said upper base (3) can be used both with the said column portions (9, 11) coupled on the corresponding column portions (8, 10) of the lower base (2), in order to evaluate the degree of centric relation movement of the dental arches, and with the condylar boxes (14) resting on the same column portions (8, 10), in order to analyse the lateral movements of the same dental arches.

9. Articulator according to claim 8, characterised by the fact that the said block (15) includes a slit (22), which develops along part of the seat (16), suitable to receive a setting screw (23) to hold the cursor (17) inside the block (15) itself.

10. Articulator according to one or more of the claims above, characterised by the fact that it includes levels (19, 20) on both sides of the upper base (3) and one level (21) on the upper face of the base (2).

11. Articulator according to claim 10, characterised by the fact that the said levels are water levels.

12. Articulator according to one or more of the claims above, characterised furthermore by the presence of:
a millimetric vertical rod (26) for the height reading (H);
a millimetric horizontal rod (26) for the length reading (L); and
an incisal rod (28) for the reading of the angle (α);
where (H), (L), and (a) define the position of the patient's dental arches.

13. Articulator according to one or more of the claims above, characterised by the fact that the upper base (3) includes a number of seats (29) suitable for inserting the incisal rod (28) in different positions relative to the articulator's median axis.

14. Articulator according to one or more of the claims above, characterised by the presence of a magnet (35) on the said cursor (17), suitable for making the latter integral with its respective joint (6, 7) in the position of the said base (3) that permits the analysis of the said lateral movements.

15. Articulator according to one or more of the claims above, characterised furthermore by the presence of suitable means to allow the selection of differentiated heights between the said joints (6, 7) and to maintain the parallelism of the said upper base (3) relative to the lower base (2).

16. Articulator according to claim 15, characterised by the fact that the said means consist of column portions (9, 11) integrally with the said block (15) and housed to slide and rotate within their respective seats (30, 31) in the said base (3).

17. Articulator according to claims 15 and 16 characterised by the fact that the said means furthermore include column portions (8, 10) made integral with the lower base (2) through the use of respective pins (36, 37) housed to slide within the corresponding seats (38, 39) provided in the said column portions (8, 10).

18. Articulator according to the claims above, characterised by the fact that at least the said column portions (9, 11) are graduated.

19. Articulator according to one or more of the claims above, characterised by the presence of a goniometric scale on the said base (3), suitable to establish the angular position of the said condylar boxes (14).
